(19) United States
(12) Patent Application Publication
(10) Pub. No.: US 2003/0149797 A1
(43) Pub. Date: Aug. 7, 2003

(54) Fast socket technology implementation using doors and memory maps

(75) Inventors: Nagendra Nagarajayya, Sunnyvale, CA (US); Sathyamangalam Ramaswamy Venkatramanan, Cupertino, CA (US); Ezhilan Narasimhan, Cupertino, CA (US)

Correspondence Address: David B. Ritchie, Thelen Reid & Priest LLP, P.O. Box 640640, San Jose, CA, 95164-0640, US

(73) Assignee: Sun Microsystems Inc., a California Corporation

(21) Appl. No.: 09/991,598

(22) Filed: Nov. 21, 2001

(51) Int. Cl. G06F 9/46; G06F 9/00

(52) U.S. Cl. 709/313; 709/328

(57) ABSTRACT

A method for moving data between processes in a computer-based system. Each process calls for one or more symbols in a first library. A second library comprises one or more equivalent symbols with Fast Sockets technology having a door interprocess communication mechanism. The call for a symbol in the first library from each process is interposed with a corresponding symbol in the second library. Each process communicates synchronization signals through the doors. Each process transfers data through a mapped memory based on the synchronization signals.

### CROSS REFERENCES

The present application is related to co-pending application entitled “Fast Socket Technology Implementation using Doors” by inventors Nagendra Nagarajayya, Sathyamangalam Ramaswamy Venkatramanan, Ezhilan Narasimhan (attorney docket number SUN-P6303). The present application is also related to co-pending application entitled “Fast Socket Technology Implementation using Memory Mapped Files and Semaphores” by inventors Nagendra Nagarajayya, Sathyamangalam Ramaswamy Venkatramanan, Ezhilan Narasimhan (attorney docket number SUN-P6305) all commonly assigned herewith.

### FIELD OF THE INVENTION

The present invention relates to interprocess communication. More particularly, the present invention relates to interprocess communication utilizing an interposition technique.

### BACKGROUND OF THE INVENTION

Interprocess communication (IPC) is the exchange of data between two or more processes. Various forms of IPC exists: pipes, sockets, shared memory, message queues, and Solaris TM doors.

A pipe provides the ability for a byte of data to flow in one direction and is used between processes. These two processes must be of common ancestry. Typically, a pipe is used to communicate between two processes such that the output of one process becomes the input of another process. FIG. 1 illustrates a conventional pipe 100 according to a prior art. The output of process 102 becomes the input of process 104. Pipe 100 is terminated when process 102 that is referencing it terminates. Data is moved from process 102 to process 104 through a pipe 100 situated within a kernel 106.

A socket is another form of IPC. It is a network of communications endpoints. FIG. 2 illustrates sockets 200 and 202 according to a prior art. A process 204 communicates with another process 206 through a couple of sockets 200 and 202 via a kernel 208. The advantages of sockets include high data reliability, high data throughput, and variable message sizes. However these features require a high setup and maintenance overhead, making the socket technique undesirable for interprocess communications on the same machine. The data availability signal 210 is transmitted through the kernel 208. Applications using sockets transfer data call a read function 212 and a write function 214. These calls make use of the kernel 208 to move data by transferring it from the user space to the kernel 208, and from the kernel 208 back to the user space, thus incurring system time. Though this kernel dependency is necessary for applications communicating across a network, it impacts system performance when used for communication on the same machine.

Shared memory is another form of IPC. FIG. 3 illustrates the use of a shared memory 300 to communicate process 302 with process 304. Shared memory is an IPC technique that provides a shared data space that is accessed by multiple computer processes and may be used in combination with semaphores. Shared memory allows multiple processes to share virtual memory space. Shared memory provides a quick but sometimes complex method for processes to communicate with one another. In general, process 302 creates/allocates the shared memory segment 300. The size and access permissions for the segment 300 are set when the segment 300 is created. The process 304 then attaches the shared memory segment 300, causing the shared segment 300 to be mapped into the current data space of the process 304. (The actual mapping of the segment to virtual address space is dependent upon the memory management hardware for the system.) If necessary, the process 302 then initializes the shared memory 300. Once created, other processes, such as process 304, can gain access to the shared memory segment 300. Each process maps the shared memory segment 300 into its data space. Each process accesses the shared memory 300 relative to an attachment address. While the data that these processes are referencing is in common, each process will use different attachment address values. Locks are often used to coordinate access to shared memory segment 300. When process 304 is finished with the shared memory segment 300, process 304 can then detach from the shared memory segment 300. The creator of the memory segment 300 may grant ownership of the memory segment 300 to another process. When all processes are finished with the shared memory segment 300, the process that created the segment is usually responsible for removing the shared memory segment 300. Using shared memory, the usage of kernel 306 is minimized thereby freeing the system for other tasks.

The fastest form of IPC on Solaris™ Operating System from Sun Microsystems Inc. is doors. However, applications that want to communicate using doors need to be explicitly programmed to do so. Even though doors IPC is very fast, the socket-based IPC is more popular since it is portable, flexible, and can be used to communicate across a network.

A definite need exists for a fast IPC technology that would overcome the drawbacks of doors and socket-based IPC. Specifically, a need exists for a fast socket technology implementation using doors and memory mapped files. A primary purpose of the present invention is to solve these needs and provide further, related advantages.

### BRIEF DESCRIPTION OF THE INVENTION

A method for moving data between processes in a computer-based system. Each process calls for one or more symbols in a first library. A second library comprises one or more equivalent symbols with Fast Sockets technology having a door interprocess communication mechanism. The call for a symbol in the first library from each process is interposed with a corresponding symbol in the second library. Each process communicates synchronization signals through the doors. Each process transfers data through a mapped memory based on the synchronization signals.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram illustrating an interprocess communication using pipes according to a prior art;

FIG. 2 is a block diagram illustrating an interprocess communication using sockets according to a prior art;

FIG. 3 is a block diagram illustrating an interprocess communication using a shared memory according to a prior art;

FIG. 4 is a block diagram illustrating an interprocess communication using the Speed Library according to a specific embodiment of the present invention;

FIG. 5 is a flow diagram illustrating a method for moving data between processes according to a specific embodiment of the present invention; and

FIG. 6 is a block diagram illustrating a memory describing an interprocess communication using the Speed Library according to a specific embodiment of the present invention.

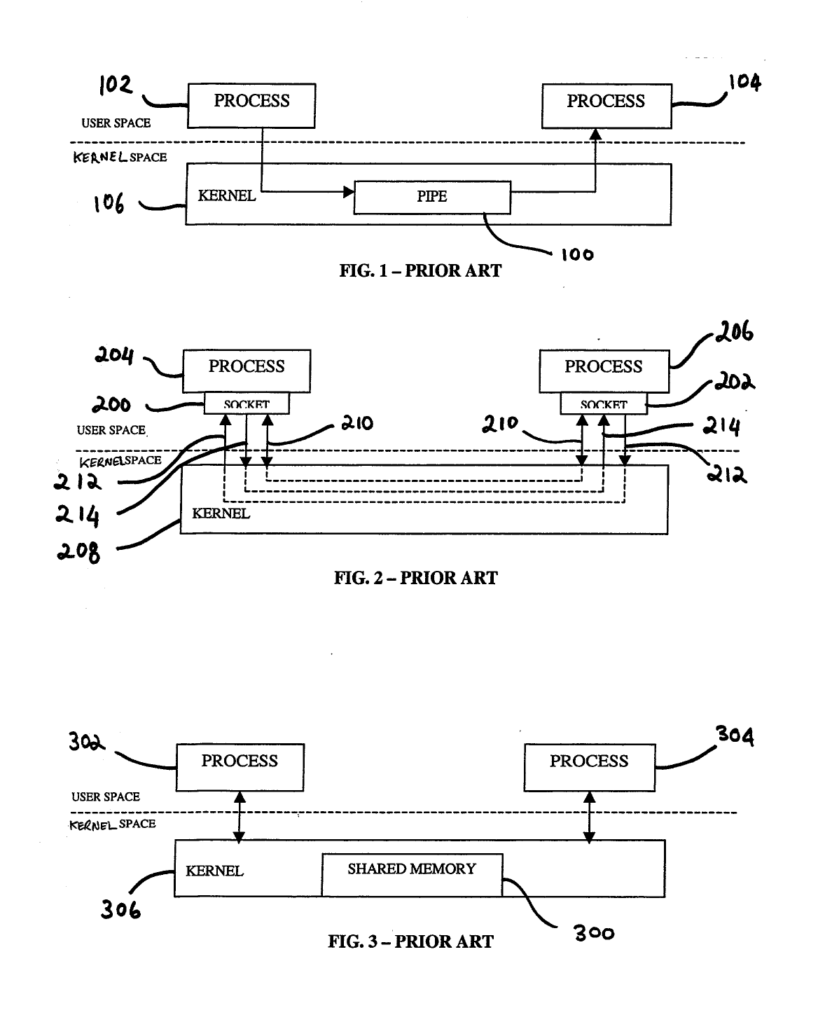

### DETAILED DESCRIPTION

Embodiments of the present invention are described herein in the context of fast socket technology using doors and memory maps. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

Doors are a mechanism for communication between computer processes (IPC). In general, a door is a portion of memory in the kernel of an operating system that is used to facilitate a secure transfer of control and data between a client thread of a first computer process and a server thread of a second computer process.

The present invention uses a Speed Library that enables a combination of doors IPC and mapped memory files. In particular, the interposition technique is used to dynamically overlay INET-TCP sockets. The Speed Library design is based on the principle that minimizing system time translates directly to a gain in application performance.

The present invention relies on the concept of interposition of shared objects. For example, dynamic libraries allow a symbol to be interposed so that if more than one symbol exist, the first symbol takes precedence over all other symbols. The environment variable LD_PRELOAD can be used to load shared objects before any other dependencies are loaded. The Speed Library uses this concept to interpose functions that will be discussed in more details below.

Speed Library interposition is needed on both the server and the client applications. This interposition allows existing client-server applications to transparently use the library. For example, on the server side, LD_PRELOAD may be used to load the shared library LIBSPEEDUP_SERVER.SO. On the client side, LD_PRELOAD may be used to load LIBSPEEDUP_CLIENT.SO.

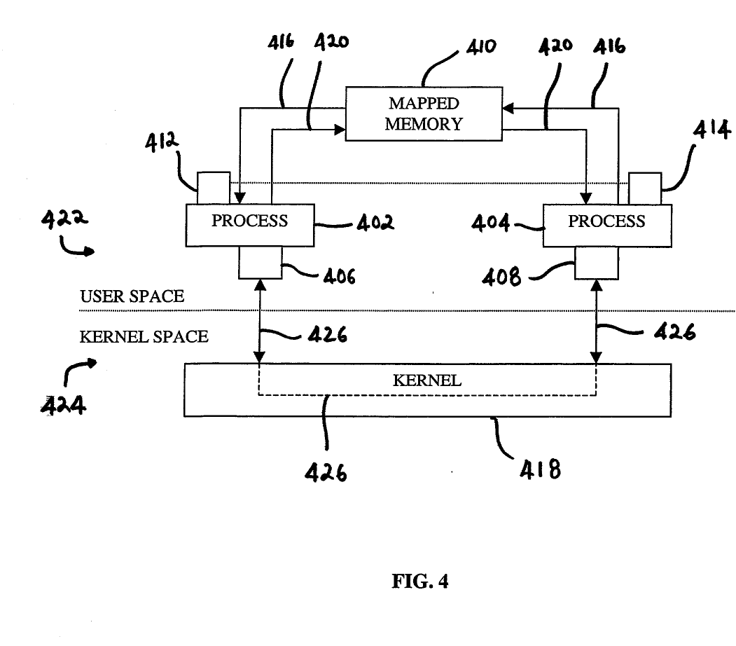

FIG. 4 is a block diagram illustrating an interprocess communication using a Speed Library according to a specific embodiment of the present invention. A process 402 communicates with another process 404 through doors 406 and 408 and mapped memory 410. Each process 402, 404 opens a TCP socket 412, 414 respectively, which is associated with a socket library (not shown). Through interposition, process calls for the socket library are intercepted and redirected to the Speed Library (not shown) that is associated with a door IPC mechanism. The Speed Library enables process 402 to communicate data availability, or synchronization signals 426, with process 404 via doors 406 and 408. Each process transfer data through the mapped memory 410.

For example, when process 402 opens socket 412 to read data from process 404 via socket 414, the read calls 416 are interposed with the Speed Library that enables doors 406 and 408. The Speed Library enables processes 402 and 404 communicate synchronization signals via the doors 406 and 408 through kernel 418. The mapped memory 410 enables data to transfer from process 404 to process 402 based on the synchronization signals without interfering with the kernel 418. When process 402 opens socket 412 to write data through socket 414 to process 404, the write calls 420 are interposed with the Speed Library that enables doors 406 and 408. The Speed Library enables processes 402 and 404 communicate synchronization signals via the doors 406 and 408 through kernel 418. The mapped memory 410 enables data to transfer from process 404 to process 402 based on the synchronization signals without interfering with the kernel 418. Both processes 402 and 404 are represented in the user space 422 while the kernel 418 is represented in the kernel space 424. Thus, the sockets 402 and 404 virtually communicate (represented by line 426) while the data and synchronization signals are actually transferred through the mapped memory 410 and doors 406, 408 respectively enabled by the Speed Library.

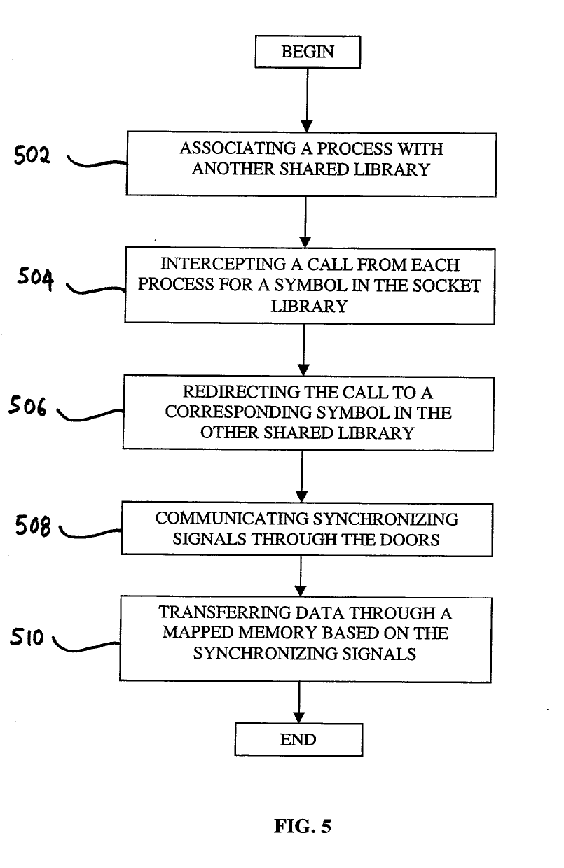

FIG. 5 is a flow diagram illustrating a method for moving data between a first process and a second process according to a specific embodiment of the present invention. In a first block 502, a second shared library, such as a Speed Library, is associated with a process through interposition. In block 504, a process call for a symbol in a first library, for example a TCP socket library, is intercepted by the interposer. The interposer in turn redirects the call for a corresponding symbol in the second shared library in step 506. The corresponding symbol enables a door for each process. The processes then communicate synchronizing signals through the doors in block 508 and transfer data through a mapped memory in block 510 based on the synchronizing signals in block 508.

Even tough the symbols are interposed, the TCP socket client-server semantics are not changed. Data and synchronizing signals are exchanged between processes. For example, a server process establishes a server socket and listens on this socket. The client process connects to this port to establish a connection, starts reading and writing information as usual. But instead of flowing through the socket, the data is transferred using the mapped memory based on data availability signals traveling through the doors.

In particular, data is copied into a mapped memory buffer to avoid making multiple copies of the data. A sliding window type of buffer management may be adopted. For every connection, the server process creates a mapped memory segment. This segment is divided into multiple windows. Each window is further divided into slots. The number and sizes of slots are configurable.

The LIBSOCKET.SO ACCEPT is no longer called for loopback connections, but it is simulated. However, LIBSOCKET.SO ACCEPT is called for connections coming across the network. The connections are automatically pooled. This was done to re-use the memory map segments instead of creating them for every connection. The server caches the connection and, if a client re-connects, a connection is returned from the pool.

Data is now directly copied using BCOPY into an available slot in the mapped memory segment. The doors IPC are used only to make a fast context switch into the server process. This makes doors extremely lightweight, resulting in very fast context switch times. The data consumption allows more slots for copying the data, as the mapped memory segment is divided into windows and slots.

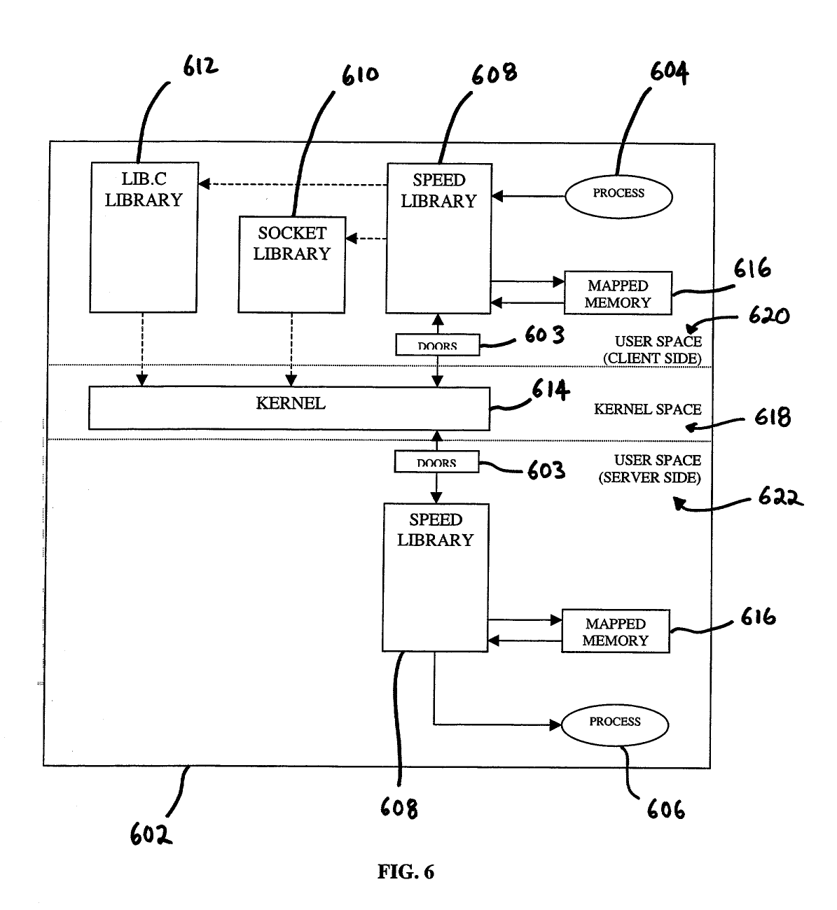

FIG. 6 illustrates a memory for moving data between processes according to a specific embodiment of the present invention. A memory 602 comprises several processes, for example processes 604 and 606, a speed library 608, a socket library 610, a lib.c library 612, a kernel 614, and a mapped memory 616. Calls from process 604 for symbols in socket library 610 or the lib.c library 612 are intercepted by the speed library 608. The speed library 608 interposes the calls from process 604 redirects the calls for symbols to corresponding symbols in speed library 608. The speed library 608 comprises a list of symbols enabling process 604 to communicate with process 606 through the doors 603 IPC mechanism. The synchronization signals are transmitted through the doors through kernel 614 belonging to the kernel space 618. Process 604 transfers data with process 606 through the mapped memory 616.

In the user space on the client side 620, the speed library 608 however redirects the calls from process 604 either to the socket library 610 or the lib.c library 612 depending on whether the speed library 608 can handle these calls. For example, the speed library 608 redirects calls to the socket library 610 for file descriptors that are associated with remote sockets (to and from other hosts). The speed library 608 also redirects calls to the lib.c library 612 for any file descriptor not associated with a socket. The redirected calls to either the lib.c library 612 and the socket library 610 enable process 604 to communicate with process 606 through the kernel 614 in the kernel space 618. The data and synchronization data are transmitted through their respective library to the process 606 back in the user space on the server side 622. For example, when process 604 calls for a remote socket in socket library 610, the data communicates through the socket library 610, the kernel 614, and back the socket library 610, and finally to process 606.

Because threads in two different processes need to be synchronized to send and receive data, a producer/consumer paradigm is used to transfer data. In transferring data from the client to the server, a write operation by the client is a read operation in the server. In other words, the client becomes the producer and the server becomes the consumer. The roles are reversed when transferring data from the server to the client, in which case the server becomes the producer and the client becomes the consumer.

Once a server socket has been created, it is named with a call to the BIND function. Since LIBSPEEDLIB_SERVER.SO is interposed on the server side, the Speed Library BIND function is called first. That is, the Speed Library establishes the doors service first and then calls the original socket BIND. The BIND function creates a new door service. It then initializes buffer management variables and obtains the actual address of the BIND function in the socket library. It then calls the LIBSOCKET.SO BIND to bind the name.

The following illustrates an example of a code for a server side BIND function of the Speed Library:

int bind(int s, const struct sockaddr *addr, socklen_t addrlen)
{
...
[Step 1]if (fptr == 0) {

cptr = ( struct sockaddr_in*) addr;
if ((did = door_create(server, DOOR_COOKIE, DOOR_UNREF)) <0) {

perror(“door_create”);
return −1;

}
sprintf(bptr, “%s%d”, NAME_SERVICE_DOOR, cptr->sin_port);
unlink(bptr);
mask = umask(0);
dfd = open(bptr, O_RDONLY|O_CREAT|O_EXCL|O_TRUNC, 0644);
umask(mask);
if (fattach(did, bptr) <0) {

perror(“fattach”);
return −1;

| | } |
|---|---|
| [Step 2] | accept_block = FALSE; |
| | if(getenv(“SPEED_ACCEPT_BLOCK”) !=0) |

accept_block = TRUE;

mutex_init(&connect_m, USYNC_THREAD, NULL);
mutex_init(&used_doors.access, USYNC_THREAD, NULL);
used_doors.front = MAX_FDS;
used_doors.number = 0;
mutex_init(&open_doors.access, USYNC_THREAD, NULL);
open_doors.index = 0;
open_doors.open = 0;
/* BUFSIZE = 8192, 8192 / 2 for r, and w, /winsz for number
of wins */
bptr = (char*)getenv(“SPEED_NOWINS”);
if (bptr == NULL)

tparams.nowins = NOWINS;

else

tparams.nowins = atoi(bptr);

if (tparams.nowins <= 0)

tparams.nowins = NOWINS;

if ((bptr = (char*)getenv(“SPEED_WINSIZE”)) == (char*)NULL)

tparams.winsz = BUTSIZE/4;

else {

tparams.winsz = atoi(bptr);

}
if (tparams.winsz <= 0)

tparams.winz = BUFSIZE/4;

tparams.bufsize = tparams.winsz * tparams.nowins * FULL_DUPLEX;
tparams.duplex = FULL_DUPLEX;
pagesize = getpagesize( );
if (pagesize < BUFSIZE)

pagesize = BUFSIZE;

tparams.pagesize = pagesize;
if(tparams.pagesize < (WINDOW_ATTR_SZ * 3 * tparams.nowins))

tparams.pagesize = (WINDOW_ATTR_SZ * 3 *

tparams.nowins);

tparams.pagesize += WINDOW_MGMT_SZ;
tparams.pagesize += (pagesize - (tparams.pagesize % pagesize));
tparams.mmap_sz = (tparams.winsz * tparams.nowins *

(tparams.duplex+1)) + tparams.pagesize;

fptr = (int (*)( ))dlsym(RTLD_NEXT “bind”);
if (fptr == NULL) {

DEBUG(fprintf(stderr, “dlopen: %s\n”, dlerror( )));
return (0);

}
sema_init(&accept_p_s, 1, USYNC_THREAD, 0);
sema_init(&accept_r_s, 0 USYNC_THREAD, 0);
closed_door_q.max_elems = MAX_FDS;
closed_door_q.first_elem = 0;
closed_door_q.last_elem = 0;
closed_door_q.no_elems = 0;

}

[Step 3]return ((*fptr)(s, addr, addrlen));
}

In step 1, the BIND function is used to establish a door service. In step 2, a DLSYM lookup is performed to obtain the actual address of the BIND function in LIBSOCKET.SO which is actually stored in the static variable FPTR and used for chaining to the actual BIND function. In step 3, the BIND function in LIBSOCKET.SO is called to establish the name.

The server side ACCEPT function is used to accept an incoming client connection request. The ACCEPT function is now simulated for loopback connections. A producer/consumer paradigm is again employed. The DOOR_SERVICE function is the producer of the connections, and the ACCEPT function is the consumer of these connections. The DOOR_SERVICE function produces connections on requests from loopback clients.

The ACCEPT function now waits on the semaphore ACCEPT_R_S for a client connection. When a client tries to establish a loopback connection, a fast context switch is made using doors IPC into the DOOR_SERVICE on the server. The mapped memory structures are created if it is a new connection, and a SEMA_POST is executed on ACCEPT_R_S by the DOOR_SERVICE thread. This wakes up the ACCEPT thread, and a successful connection is created. The TCP ephemeral port is also simulated.

The following illustrates an example of a code for a server side ACCEPT function of the Speed Library:

void door_service(void *cookie, char *argp, size_t arg_size,
door_desc_t*dp,uint_t n_descriptors)
{
...

} else if (ptr->type == CONNECT) {

| | |
|---|---|
| [Step1] | client_doorinfo *ptr = (client_doorinfo*)argp; |
| | size = ptr->size; |
| | mutex_lock(&connect_m); /* At the moment connect requests */ |

/* are serialized, slowing down this segment */
while(sema_wait(&accept_p_s));

| | |
|---|---|
| [Step2] | connectport = −1; |
| | if (ptr->port > 0) |

connect_port = ptr->port;

accept_fd = socket(AF_INET, SOCK_STREAM, 0);
if (connect_port = −1) {

connect_port = port_avail;
port_avail++;
port_avail %= szshort;

| | } |
|---|---|
| [Step3] | accept_fd = door_accept(accept_fd, &client, |

sizeof(client), 1);

if (accept fd == −1) {

ptr->port = −1;
sema_post(&accept_p_s);
mutex_unlock(&connect_m);
door_return((char*)ptr, size, NULL, 0);

| | } |
|---|---|
| [Step4] | ptr->port = client.sin_port; |
| | pmap[fd].state = INUSE; |
| | doconnect(accept_fd, (client_doorinfo*)ptr); |
| | accept_count++; |
| | sema_post(&accept_r_s); |
| | mutex_unlock(&connect_m); |
| | door_return((char*)ptr, size, NULL, 0); |

In step 1, connections at the moment are serialized. SEMA_WAIT is performed to check if ACCEPT_R is free to create a client connection. In step 2, the CONNECT_PORT will be set to “−1” if it is a new connection and will have a value if it is pooled. In step 3, mapped memory segments and data structures needed for the connection are created. In step 4, if the connection is successful, connection information is returned to the client.

int accept(int s, struct sockaddr *addr, Psocklen_t addrlen)
{
...
[Step 1]for(;;) {

if (sema_wait(&accept_r_s)) {

for (j=0; j<100; j++);

} else

break;

}

[Step 2]accept_count--;

client = (struct sockaddr_in *)addr;
client->sin_addr.s_addr = htonl(INADDR_LOOPBACK);
client->sin_family = AF_INET;
client->sin_port = htons(connect_port);
fildes = accept_fd;
sema_post(&accept_p_s);
return fildes;

In step 1, connections at the moment are serialized. SEMA_WAIT is executed for a client connection request. In step 2, a TCP connection data is simulated. A SEMA_POST is executed to signal DOOR_SERVICE of a successful connection.

The READ function on the server side is a consumer of the client-write data. When the server tries to read data on a file descriptor, the Speed library READ function is called because it is interposed. A check is first made to see whether the file descriptor matches the established file descriptor. If so, the READ function waits on the semaphore RD_OCCUPIED. For all other file descriptors, the Speed library function transfers control to the LIBC.SO READ.

Since a sliding window type of protocol is used, some calculation is required to find the correct window and the correct slot in the window. When the client writes data, the data is copied into a mapped memory slot, and a fast context switch is performed into the DOOR_SERVICE on the server. The door service performs a SEMA_WAIT on the RD_EMPTY semaphore and, if successful, executes a SEMA_POST operation on the RD_OCCUPIED semaphore. The SEMA_POST wakes up the READ thread. The READ thread copies the data using BCOPY and executes a SEMA_POST on the RD_EMPTY semaphore.

The following illustrates an example of a code for a server side READ function of the Speed Library:

ssize_t read(int fd, void *buf, size_t nbyte)
{
...

if(fd > 0 && pmap[fd].fd == fd) {

| | |
|---|---|
| [Step1] | w_mgmt_ptr = pmap[fd].r_w_mgmt_ptr; |
| | if(pmap[fd].partial_read_flag == 0) { |

rd_occupied--;
whule(sema_wait(&pmap[fd].rd_occupied));

| | } |
|---|---|
| [Step2] | win = w_mgmt_ptr[SERVER_ACTIVE_WIN]; |
| | w_attr_ptr = (int*)(pmap[fd].r_w_attr_ptr_offset + |

WINDOW_INDEX(win));

| | mptr = pmap[fd].r_mptr; |
|---|---|
| | w_dptr = mptr + w_attr_ptr[DBUF_OFFSET]; |
| | w_dptr = w_dptr + w_attr_ptr[START_ADDR]; |
| [Step3] | if(nbyte <= w_attr_ptr[CSZ]) { |

bcopy(w_dptr, buf, nbyte);
w_attr_ptr[START_ADDR] = nbyte;
w_attr_ptr[CSZ] = w_attr_ptr[CSZ] - nbyte;

} else if(nbyte > w_attr_ptr[CSZ]) {

bcopy(w_dptr, buf, w_attr_ptr[CSZ]);
nbyte = w_attr_ptr[CSZ];
w_attr_ptr[CSZ] = 0;

| | } |
|---|---|
| [Step4] | if(w_attr_ptr[CSZ] == 0) { |

w_attr_ptr[START_ADDR] = 0;
w_mgmt_ptr[SERVER_ACTIVE_WIN] ++;
w_mgmt_ptr[SERVER_ACTIVE_WIN]
w_mgmt_ptr[SERVER_ACTIVE_WIN]

% tparams.nowins;

rd_empty++;
pmap[fd].partial_read_flag = 0;
sema_post(&pmap[fd].rd_empty);

} else {

pmap[fd].partial_read_flag = 1;

}

...
}
void door_service(void *cookie, char *argp,
size_t arg_size, door_desc_t*dp, uint_t n_descriptors)
{
...

} else if (ptr->type == WRITE) {

| | |
|---|---|
| ... | |
| [Step 5] | while(sema_wait(&pmap[fd].rd_empty)); |
| | mptr = (int*)pmap[fd].mdoor.mptr; |
| | w_mgmt_ptr = mptr + WINDOW_MGMT_BEGIN; |
| | w_mgmt_ptr[CLIENT_ACTIVE_WIN]++; |
| | w_mgmt_ptr[CLIENT_ACTIVE_WIN] = |

w_mgmt_ptr[CLIENT_ACTIVE_WIN] % tparams.nowins;

sema_post(&pmap[fd].rd_occupied);

...
}

The WRITE function on the server side is a producer of the client-read data. When the server tries to WRITE data on a file descriptor, the Speed function WRITE is called since it is interposed. First, a check is made to see whether the file descriptor matches the established connection file descriptor, and, if so, the WRITE function waits on the semaphore WR_EMPTY. Otherwise, the file descriptor is transferred to the WRITE function of socket library. If successful, the data is copied using BCOPY into a memory mapped slot. A SEMA_POST on the WR_OCCUPIED semaphore is executed to wake up the DOOR_SERVICE thread. When the client tries to read some data, a fast context switch is made into the DOOR_SERVICE on the server, and a SEMA_WAIT is executed on the WR_OCCUPIED semaphore. A SEMA_POST on RD_OCCUPIED semaphore is executed to wake up the READ thread. Finally, the READ thread copies the data using BCOPY and a SEMA_POST on WR_EMPTY is executed.

The following illustrates an example of a code for a server side WRITE function of the Speed Library:

ssize_t write(int fd, const void *buf size_t nbyte)
{
...

| | if(fd > 0 && pmap[fd].fd == fd) { |
|---|---|
| 1 | cbuf = (void*)buf; |

csz = nbyte;
w_mgmt_ptr = pmap[fd].w_w_mgmt_ptr;
mptr = pmap[fd].w_mptr;
while(csz > 0) {
wr_empty--;
sema_ptr = (sema_t*)&pmap[fd].wr_empty;
while(sema_wait(&pmap[fd].wr_empty));

| | |
|---|---|
| 2 | win = w_mgmt_ptr[CLIENT_ACTIVE_WIN]; |

w_attr_ptr = (int*) (pmap[fd].w_w_attr_ptr_offset +
WINDOW_INDEX(win));
w_dptr = mptr + w_attr_ptr[DBUF_OFFSET];
if(csz <= w_attr_ptr[SZ]) {

bcopy(cbuf, w_dptr, csz);
w_attr_ptr[CSZ] = csz;
cbuf = ((char*)cbuf) + csz;
csz = 0;

} else if (csz > w_attr_ptr[SZ]) {

bcopy(cbuf, w_dptr, w_attr_ptr[SZ]);
w_attr_ptr[CSZ] = w_attr_ptr[SZ];
csz = csz − w_attr_ptr[SZ];
cbuf = ((char*)cbuf) + w_attr_ptr[SZ];

}
w_mgmt_ptr[CLIENT_ACTIVE_WIN]++;
w_mgmt_ptr[CLIENT_ACTIVE_WIN] =
w_mgmt_ptr[CLIENT_ACTIVE_WIN] %

tparams.nowins;

wr_occupied++;
sema_ptr = (sema_t*)&pmap[fd].wr_occupied;
sema_post(&pmap[fd].wr_occupied);

}

...
}
void door_service(void * cookie, char *argp size_t arg_size,
door_desc_t*dp, uint_t n_descriptors)
{

if (ptr->type == READ) {

while(sema_wait(&pmap[fd].wr_occupied));

...

sema_post(&pmap[fd].wr_empty);
door_return((char*)&ptr->ret, sizeof(int), NULL, 0);

}

The client side CONNECT function performs a fast context switch to the DOOR_SERVICE to set up a connection with the server. On the return from the door service, the shared memory mapped segment is mapped into the client address space. The CONNECT function then caches client connections. If the client reconnects, it sends the cached descriptor to the server to reestablish the connection.

The READ function is similar to the READ function from the server side, except that it is on the client side. When the client calls read to get data from the server, the Speed version of READ is called. A check is first made to ensure that the file descriptor matches the established connection. If the file descriptors are not valid, they are transferred to the READ function of the socket library. A fast context switch is then made into the server door_service. The READ function then waits for server-write data. On return from the door call, the server data is copied into the client buffer from the memory mapped slot using bcopy.

The following illustrates an example of a code for a client side READ function of the Speed Library:

ssize_t read(int fildes, void *buf, size_t nbyte)
{
...

if(fildes > 0 && dinfo[fildes].fd == fildes) {

if(dinfo[fildes].partial_read_flag == 0) {

...

| [Step1] | dinfo[fildes].rinfo.size=nbyte; |
|---|---|
| | dinfo[fildes].rinfo.type=READ; |
| | dinfo[fildes].rinfo.port = dinfo[fildes].port; |
| | darg.data_ptr = (char *)&dinfo[fildes].rinfo; |
| | darg.data_size = sizeof(readinfo); |
| | darg.desc_ptr = NULL; |
| | darg.desc_num = 0; |
| | darg.rbuf = (char*)&dinfo[fildes].rinfo.ret; |
| | darg.rsize = sizeof(int); |
| | /* semapore block on occupied will happen |
| | in the door server */ |
| | door_call(door_fd, &darg); |
| | if(dinfo[fildes].rinfo.ret == −1) { |

dinfo[fildes].state = CLOSE;
return 0;

}
if (dinfo[fildes].rinfo.ret > 0) {

dinfo[fildes].rinfo.nowins =
dinfo[fildes].rinfo.ret;
dinfo[fildes].rinfo.nowins--;
dinfo[fildes].state = IN_CLOSE;

}
}

| | } |
|---|---|
| [Step2] | mptr = dinfo[fildes].r_mptr; |
| | win = w_mgmt_ptr[SERVER_ACTIVE_WIN]; |
| | w_attr_ptr = (int*)(dinfo[fildes].r_w_attr_ptr_offset + |
| | WINDOW_INDEX(win)); |
| | w_dptr = mptr + w_attr_ptr[DBUF_OFFSET]; |
| | w_dptr = w_dptr + w_attr_ptr[START_ADDR]; |
| | if (nbyte <= w_attr_ptr[CSZ]) { |

bcopy(w_dptr, buf, nbyte);
w_attr_ptr[START_ADDR] = nbyte;
w_attr_ptr[CSZ] = w_attr_ptr[CSZ] - nbyte;

} else if (nbyte > w_attr_ptr[CSZ]) {

bcopy(w_dptr, buf, w_attr_ptr[CSZ]);
nbyte = w_attr_ptr[CSZ];

w_attr_ptr[CSZ] = 0;
}
if (w_attr_ptr[CSZ] == 0) {

w_attr_ptr[START_ADDR] = 0;
w_mgmt_ptr[SERVER_ACTIVE_WIN] ++;
w_mgmt_ptr[SERVER_ACTIVE_WIN] =
w_mgmt_ptr[SERVER_ACTIVE_WIN]

% tparams.nowins;

dinfo[fildes].partial_read_flag = 0;

}else {

dinfo[fildes].partial_read_flag = 1;

}
return nbyte;

}

}

When the client calls WRITE to send data to the server, the client side Speed WRITE is called. A check is first made to ensure that the file descriptor matches the established connection. If so, the WRITE data is copied using bcopy to a memory mapped slot. A fast context switch is also performed into the server door service to wake up the waiting server READ thread. If the file descriptor is invalid, the file descriptors are transferred to the READ function of the socket library.

The following illustrates an example of a code for a client side WRITE function of the Speed Library:

ssize_t write(int fildes, const void *buf, size_t nbyte)
{

if(fildes > 0 && dinfo[fildes].fd == fildes) {

cbuf = (void*)buf;

csz = nbyte;
w_mgmt_ptr = dinfo[fildes].w_w_mgmt_ptr;
mptr = dinfo[fildes].w_mptr;
while(csz > 0) {
win = w_mgmt_ptr[CLIENT_ACTIVE_WIN];
w_attr_ptr = (int*) (dinfo[fildes].w_w_attr_ptr offset +

WINDOW_INDEX(win));

w_dptr = mptr + w_attr_ptr[DBUF_OFFSET];

if(csz <= w_attr_ptr[SZ]) {

bcopy(cbuf, w_dptr, csz);
w_attr_ptr[CSZ] = csz;
cbuf = ((char*)cbuf) + csz;
csz = 0;

} else if (csz > w_attr_ptr[SZ]) {

bcopy(cbuf, w_dptr, w_attr_ptr[SZ]);
w_attr_ptr[CSZ] = w_attr_ptr[SZ];
csz = csz − w_attr_ptr[SZ];
cbuf = ((char*)cbuf) + w_attr_ptr[SZ];

}
dinfo[fildes].winfo.size=nbyte;
dinfo[fildes].winfo.type=WRITE;
dinfo[fildes].winfo.port= dinfo[fildes].port;
darg.data_ptr = (char *)&dinfo[fildes].winfo;
darg.data_size = sizeof(writeinfo);
darg.desc_ptr = NULL;
darg.desc_num = 0;
darg.rbuf = NULL;
darg.rsize =0;
door_call(door_fd &darg);

}
return nbyte;

}

...
}

As previously discussed, the data is moved through mapped memory that are shared for each connection. The mapped memory segment is divided into windows, and each window is divided into slots. The number of windows is not configurable at this time, but the number and size of slots are configurable through environment variables.

Connections are automatically pooled and cached by the server. Doors are just used for signaling and fast context switching. Also, doors service produces connections on client requests.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for moving data between processes in a computer-based system, each process calling for one or more symbols in a first library, the method comprising:
associating each process with a second library, said second library comprising one or more symbols with a door interprocess communication mechanism, said door interprocess mechanism enabling each process to communicate a synchronization signal, said one or more symbols enabling data communication through a mapped memory based on said synchronization signal;
intercepting a call from each process for a symbol in said first library; and
redirecting said call to a corresponding symbol in said second library.

2. A method according to claim 1 wherein said first library comprises one or more symbols associated with a socket interprocess communication mechanism.

3. A method according to claim 1 wherein said associating further comprises dynamically linking each process with said second library.

4. A method according to claim 1 wherein said second library comprises one or more server-side symbols and one or more client-side symbols.

5. A method according to claim 4 wherein said server-side symbols further comprise a bind symbol, an accept symbol, a read symbol, and a write symbol.

6. A method according to claim 4 wherein said client-side symbols further comprise a connect symbol, a read symbol, and a write symbol.

7. A program storage device readable by a machine, tangibly embodying a program of instructions readable by the machine to perform a method for moving data between processes in a computer-based system, each process calling for one or more symbols in a first library, the method comprising:
associating each process with a second library, said second library comprising one or more symbols with a door interprocess communication mechanism, said door interprocess mechanism enabling each process to communicate a synchronization signal, said one or more symbols enabling data communication through a mapped memory based on said synchronization signal;
intercepting a call from each process for a symbol in said first library; and
redirecting said call to a corresponding symbol in said second library.

8. The program storage device according to claim 7 wherein said first library comprises one or more symbols associated with a socket interprocess communication mechanism.

9. The program storage device according to claim 7 wherein said associating further comprises dynamically linking each process with said second library.

10. The program storage device according to claim 7 wherein said second library comprises one or more server-side symbols and one or more client-side symbols.

11. The program storage device according to claim 10 wherein said server-side symbols further comprise a bind symbol, an accept symbol, a read symbol, a write symbol, and a close symbol.

12. The program storage device according to claim 10 wherein said client-side symbols further comprise a connect symbol, a read symbol, a write symbol, a close symbol, and a thread_create symbol.

13. An apparatus for moving data between process in a computer-based system, the apparatus comprising:
a plurality of processes;
a mapped memory;
a first library having one or more symbols, said plurality of processes calling for said one or more symbols in said first library of symbols;
a second library having one or more symbols, said one or more symbols associated with a door interprocess communication mechanism; and
an interposer intercepting a call from a process for said one or more symbols in said first library and redirecting a call for corresponding said one or more symbols in said second library.

14. The apparatus according to claim 13 wherein said first library comprises one or more symbols associated with a socket interprocess communication mechanism.

15. The apparatus according to claim 13 wherein each process is dynamically linked with said second library.

16. The apparatus according to claim 13 wherein each process communicates a synchronization signal through a door, said door enabled by said door interprocess communication mechanism.

17. The apparatus according to claim 16 wherein each process transfers data through said mapped memory based on said synchronization signal.

18. The apparatus according to claim 13 wherein said second library further comprises one or more server-side symbols and one or more client-side symbols.

19. The apparatus according to claim 18 wherein said server-side symbols further comprise a bind symbol, an accept symbol, a read symbol, a write symbol, and a close symbol.

20. The apparatus according to claim 18 wherein said client-side symbols further comprise a connect symbol, a read symbol, a write symbol, a close symbol, and a thread_create symbol.

21. An apparatus for moving data between processes in a computer-based system, each process calling for one or more symbols in a first library, the apparatus comprising:
means for associating each process with a second library, said second library comprising one or more symbols with a door interprocess communication mechanism, said door interprocess mechanism enabling each process to communicate a synchronization signal, said one or more symbols enabling data communication through a mapped memory based on said synchronization signal;
means for intercepting a call from each process for a symbol in said first library; and
means for redirecting said call to a corresponding symbol in said second library.
